(19) United States
(12) Patent Application Publication
(10) Pub. No.: US 2008/0314194 A1
(43) Pub. Date: Dec. 25, 2008

(54) CLINCHING LINEAR SLIDE DEVICE

(75) Inventor: Michael J. Maloney, Doylestown, PA (US)

Correspondence Address: GREGORY J. GORE, 70 WEST OAKLAND AVENUE, SUITE 316, DOYLESTOWN, PA, 18901, US

(73) Assignee: PEM Management, Inc., Wilmington, DE (US)

(21) Appl. No.: 12/142,955

(22) Filed: Jun. 20, 2008

Related U.S. Application Data
(60) Provisional application No. 60/945,494, filed on Jun. 21, 2007.

(51) Int. Cl. F16H 25/16

(52) U.S. Cl. 74/640

(57) ABSTRACT

The present invention permits linear slide motion as well as rotational motion between two sheets or panels of metal. This linear rail system utilizes clinching end stays to hold a loop of wire taut in a milled or stamped slot in a sheet metal panel. The loop of wire is stretched in the milled slot, being wrapped through the undercuts of the clinching end stays. When the stays are pressed into the milled slot with the wire in place, the wire is locked in due to the cold flow of metal around it. The taut spring wire captivates a round follower with flanges above and below the wire runs. The follower is then free to move linearly and rotate in the panel. This follower is self-clinching and can attach a second sheet to the assembly by pressing a hole in the second sheet onto the follower.

### RELATED APPLICATIONS

The present patent application is related to U.S. Provisional Patent Application Ser. No. 60/945,494 filed Jun. 21, 2007 entitled “Clinching Linear Slide Device,” priority from which is hereby claimed.

### FIELD OF THE INVENTION

This invention relates to movable joints between components; more specifically, it relates to a guide rail and follower combination which provides linear and/or rotational motion between attached components.

### BACKGROUND OF THE INVENTION

Linear guide rails and followers are common mechanical components used in various machines that require a component's motion to be restricted to a straight line. There is a current trend toward hand held devices which exhibit controlled motion, such as cell phones with sliding and pivoting displays, and laptop or hand held computers. This market has placed demand on miniature mechanical devices which reliably produce the kind of motion common on much larger devices.

Other methods to achieve this kind of motion include a track and a follower, which includes a slot and a pin with a head on it. This assembly is not flush with the surface of the sheets. Small ball-bearing slides are available for linear motion, but their range for linear motion is restricted, and they do not rotate. An additional drawback is that they do not assemble flush with the panels.

### SUMMARY OF THE INVENTION

The present invention was devised to fill the need to create small machines, such as cell phones with moving displays, which are continuously undergoing design enhancements to add complex motion in ever smaller packages. This invention permits linear slide motion, as well as rotational motion if desired, between two sheets or panels of metal with little or no additional space needed between or outside the surfaces of the panels being connected. This invention utilizes self-clinching technology to mount a loop of wire in a slot to act as linear rails. A self-clinching follower is captivated between the taut sides of the loop, permitting linear and rotational motion, or just linear motion if required.

In one form, the invention is a miniature clinching linear slide mechanism. The device provides linear slide rails within a slot in a sheet of steel. A clinching follower for the rails will clinch to a second sheet. The motion permitted by this joinder is linear, as well as rotational, if only one follower is used. If two followers or a rectangular follower is used, motion is restricted to linear.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front top right exploded assembly view of the major components of the invention as labeled and described.

FIG. 2 is a top right front view of the components shown in FIG. 1 in their assembled state.

### DESCRIPTION OF THE PREFERRED EMBODIMENT

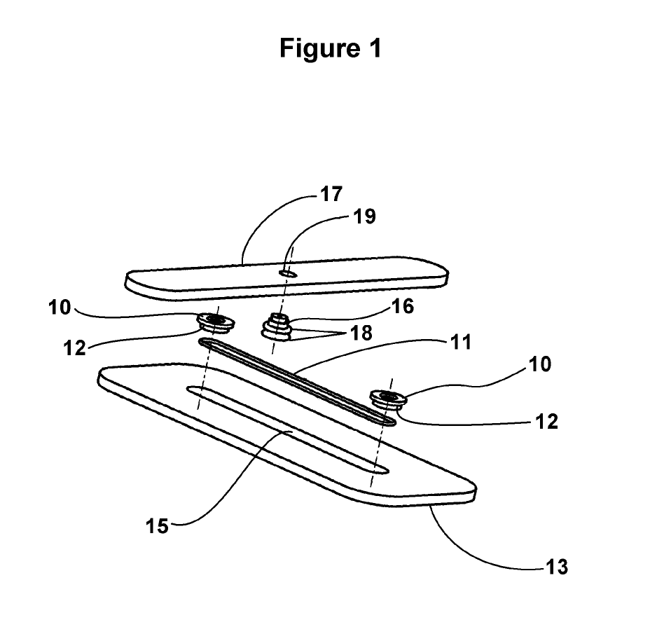

Referring now to FIG. 1, this linear rail system utilizes clinching end stays 10 to hold a loop of wire 11 taut in a milled or stamped slot 15 in a sheet metal panel 13. The loop 11 of wire is stretched in the milled slot, being wrapped through the undercuts 12 of the clinching end stays 10. When the stays 10 are pressed into the milled slot 15 with the wire in place, the wire is locked in due to the cold flow of metal around it. The taut spring wire captivates a round follower 16 with flanges 18 above and below the wire runs. The follower 16 is then free to move linearly and rotate in the panel 13. This follower is self clinching and can attach a second sheet 17 to the assembly by sheet 17 pressing onto the follower 16. Hole 19 is provided to receive the clinch end of the follower.

The assembly procedure is accomplished by placing the end stays (clinch profile up) over spring loaded pins which are the same distance, center to center, as the slot length to which they are being installed. The follower is placed between the end stays on this apparatus in a precisely positioned counter bore (clinch profile down or up). Once on the pins, the wire is wrapped tightly through the undercuts of the end stays, passing through the groove in the follower on each side. The wire is twisted tightly, keeping the connection within the clinch area of one of the end stays. The slotted panel is then pressed onto the positioned components, locking the end stays and wire in place. The moving sheet 17 is then pressed onto the follower captured in panel 13 using a flat punch and anvil.

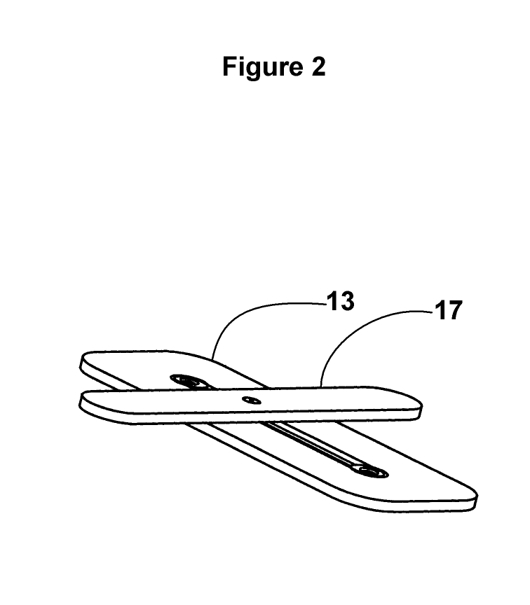

The resulting assembly of sheet 17 to panel 13 is shown in FIG. 2. This joinder of sheet permits linear as well as rotational motion, but linear motion only is also possible, either by using two followers instead of one in an additional hole in line with the first follower or by using a rectangular follower (not shown). These components can be presented separately or partially assembled. It may be more practical to have the wire loop preformed and welded to the end stays to ensure its integrity. Two pins, in an installation anvil, which could be spread apart would provide a method for tensioning the wires prior to pressing.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

What is claimed is:

1. A slide assembly, comprising:
a first planar sheet having a circular aperture therethrough;
a follower including clinch means rigidly affixed into said first sheet through said first aperture;
a second panel having an elongate linear slot therethrough, said slot having opposing first and second ends;
two stays, each attached to the second panel at one end of said slot ends;
a flexible elongate wire loop captured by and tensively extending between said stays; and
wherein said follower engages said slot and includes a groove which receives said wire between diametrically opposed sides thereof, thereby joining said first sheet to said second panel rotatably and slidably.

2. The slide assembly of claim 1 wherein said stays are fixed to said second panel by clinch attachment.

3. The slide assembly of claim 2 further described in that said first sheet is moveable while said second panel is stationary.

4. The slide assembly of claim 2 wherein said first sheet and said second panel are composed of metal.

5. The slide assembly of claim 1 including two followers affixed to said first sheet, each engaging said slot and said wire.

6. The slide assembly of claim 1 wherein end portions of said wire loop lie within clinch undercuts of said stays.
